(19) United States
(12) Patent Application Publication
(10) Pub. No.: US 2018/0186698 A1
(43) Pub. Date: Jul. 5, 2018

(54) POROUS ALUMINA CERAMIC WARE AND PREPARATION METHOD THEREOF

(71) Applicant: SUNTECH ADVANCED CERAMICS (SHENZHEN) CO., LTD, Shenzhen (CN)

(72) Inventors: Hui YANG, Shenzhen (CN); Qijun XIANG, Shenzhen (CN); Yicheng TAN, Shenzhen (CN)

(73) Assignee: SUNTECH ADVANCED CERAMICS (SHENZHEN) CO., LTD, Shenzhen (CN)

(21) Appl. No.: 15/741,126

(22) PCT Filed: Jul. 6, 2015
(86) PCT No.: PCT/CN2015/083391

§ 371 Date: Dec. 29, 2017

(51) Int. Cl. C04B 35/10; C04B 35/624; C04B 35/632; C04B 35/626; C04B 35/64

(52) U.S. Cl. CPC C04B 35/10; C04B 35/624; C04B 35/632; C04B 35/6264; C04B 2235/6567; C04B 35/64; C04B 2235/3217; C04B 2235/3418; C04B 2235/604; C04B 35/6261

(57) ABSTRACT

Provided are a porous alumina ceramic ware and a preparation method thereof. The porous alumina ceramic material comprises the following components at the following percentages by mass: 40%-60% of alumina, 30%-50% of diatomaceous earth, and 6%-15% of silicon sol, wherein silicon dioxide makes up 25%-30% of the mass of the silicon sol.

### FIELD OF THE INVENTION

The present disclosure relates to the field of ceramic materials, and more particularly relates to a porous alumina ceramic and preparation method thereof.

### BACKGROUND OF THE INVENTION

Porous ceramic is a new type of ceramic material, which has evenly distributed pores, a very large specific surface area, unique physical surface properties, a selective permeability to liquids and gases media and is capable of absorbing energy (such as sound waves) or has damping characteristics. In addition, the porous ceramic has a higher porosity and a small bulk density. Meanwhile, the ceramic material itself has excellent properties such as high temperature resistance, friction resistance, corrosion resistance, high strength, high hardness, and high elastic modulus, which makes the porous ceramic as a green material can be widely used in many aspects such as gas or liquid filtration, purification and separation, chemical catalytic carrier, noise absorption and shock absorption, advanced insulation materials, bio-implanted materials, special wall materials and sensor materials.

In many porous ceramic materials, porous alumina ceramics have become the most widely used porous ceramic materials due to their excellent characteristics of cheap raw materials, high material strength, low manufacturing cost, low thermal conductivity, and aging resistance properties. Porous alumina ceramic refers to a ceramic that internally forms a plurality of interconnected or closed pores during the material forming and high temperature sintering using alumina as framework. Porous alumina ceramics are generally prepared by extrusion molding, particle accumulation to form a pore structure, gas foaming to form a porous structure, organic foam impregnation molding method, pore forming agent method, sol-gel method, and gel injection molding method. Among these preparation methods, the pore forming agent method is widely used due to the advantages of simple process, short preparation period, controllable pore diameter and porosity, and excellent strength of the prepared porous ceramic.

However, the porosity of porous alumina ceramics currently prepared using the pore forming agent method is relatively low, which is generally less than 50%, resulting in poor permeability. While slightly higher porosity will lead to a reduced strength of the porous alumina ceramic, which will directly affect its normal use.

### SUMMARY

Therefore, it is necessary to provide a porous alumina ceramic, which has a good permeability and an excellent strength.

In addition, a method of preparing a porous alumina ceramic is also provided.

A porous alumina ceramic, wherein a raw material of the porous alumina ceramic includes the following components: by weight percentage, 40% to 60% of alumina, 30% to 50% of diatomite, and 6% to 15% of silica sol. A weight percentage of silica in the silica sol is 25% to 30%.

A method of preparing the porous alumina ceramic includes the following steps of:

weighing the following components, by weight percentage, 40% to 60% of alumina, 30% to 50% of diatomite, and 6% to 15% of silica sol, wherein a weight percentage of silica in the silica sol is 25% to 30%;

pre-treating the diatomite with a sealing agent, wherein the sealing agent is paraffin wax or polyethylene glycol;

mixing a pretreated diatomite, the silica sol, and the alumina in water to obtain a mixed slurry;

drying and crushing the mixed slurry to obtain a composite powder;

molding the composite powder to obtain a green body; and

sintering the green body at a temperature ranging from 1450° C. to 1600° C. for 1 hour to 5 hours to obtain the porous alumina ceramic.

In one of the embodiments, the step of pre-treating the diatomite with the sealing agent includes: dissolving the sealing agent in a solvent to obtain a pretreatment solution, wherein a mass ratio of the sealing agent and the diatomite ranges from 10 to 25:100; adding the pretreatment solution after the diatomite is vacuumized until a vacuum degree ranges from 5 Pa to 10 Pa, and then obtaining the pretreated diatomite after filtration and drying.

In one of the embodiments, a weight percentage of the sealing agent in the pretreatment solution is 10% to 20%.

In one of the embodiments, the solvent is kerosene, n-hexane or xylene.

In one of the embodiments, prior to the step of pre-treating the diatomite with a sealing agent, the method further includes a step of granulating the diatomite: ball-milling the diatomite, and then sifting the diatomite through a 100 mesh to 200 mesh sieve.

In one of the embodiments, the step of mixing the pretreated diatomite, the silica sol, and the alumina in water includes: ball-milling the alumina in water for 10 hours to 30 hours to obtain an alumina slurry; and then mixing and ball-milling the pretreated diatomite, the silica sol, and the alumina slurry.

In one of the embodiments, during the step of mixing and ball-milling the pretreated diatomite, the silica sol, and the alumina slurry, a rotating speed during ball milling is 5 to 15 revolutions per minute.

In one of the embodiments, during the step of mixing and ball-milling the pretreated diatomite, the silica sol, and the alumina slurry, a ratio of a sum of mass of the pretreated diatomite, the silica sol, and the alumina slurry to that of a ball mill medium ranges from 1:0.5 to 1.

In one of the embodiments, during the step of ball-milling the alumina in water, a mass ratio of the alumina, a ball mill medium, and the water ranges from 1:3 to 5:0.5 to 1.

In the raw materials of aforementioned porous alumina ceramic, the diatomite is used as a pore forming agent. Since the diatomite is a biomineral material formed by millions of years of sedimentary mineralization of the remains of the single-celled lower aquatic plant diatoms in sea and river, the use of diatomite as the pore forming agent can enable the porous alumina ceramic to have a unique and orderly arranged microporous structure, such that the ceramic has a high porosity, a suitable pore diameter, and a higher open porosity. The alumina makes the ceramic has a good strength. The silica sol serves as a binding phase between the alumina and the diatomite. The strength of the porous alumina ceramic is further enhanced by in-situ formation of the mullite phase at the contact position of the alumina and the diatomite, such that the porous alumina ceramic cooperatively obtained by diatomite, alumina, and silica sol has a good permeability and an excellent strength.

### BRIEF DESCRIPTION OF THE DRAWINGS

FIG. 1 is a flowchart of a method of preparing a porous alumina ceramic according to an embodiment.

### DETAILED DESCRIPTION OF THE EMBODIMENTS

The porous alumina ceramic and the preparing method thereof will be further described in detail hereinafter with reference to the accompanying drawings and the specific embodiments.

A raw material of a porous alumina ceramic according to an embodiment includes the following components, by weight percentage, 40% to 60% of alumina, 30% to 50% of diatomite, and 6% to 15% of silica sol.

The alumina is preferably α-alumina.

The diatomite serves as a pore forming agent of the porous alumina ceramic. The diatomite is a biomineral material formed by millions of years of sedimentary mineralization of the remains of the single-celled lower aquatic plant diatoms in sea and river, such that it has a unique and orderly arranged microporous structure, high porosity (up to 80% to 92%), wide pore diameter distribution, light weight, small bulk density (bulk density of 0.3 g/cm³ to 0.5 g/cm³), large specific surface area, low thermal conductivity, high adsorption and activity and other advantages, thus making diatomite an excellent pore forming material. Due to the poor mechanical strength of diatomite and the good mechanical strength of alumina, porous ceramics with better strength can be obtained by using diatomite and alumina cooperatively as raw materials.

In addition, as the pore forming agent, diatomite does not produce toxic gases during the sintering process, which is very environmentally friendly, such that the use of the pore forming agent (such as sodium chloride, calcium sulfate and the like) that does not decompose and volatilize when sintered at a high temperature can be avoided. Sodium chloride, calcium sulfate and the like will participate in the sintering reaction, the performance of porcelain have serious adverse effects, especially for high purity ceramic components.

The diatomite has a pore diameter of 40 μm to 80 μm.

A weight percentage of silica in the silica sol is 25% to 30%. The silica sol is a dispersion of silica particles in water or in a solvent such as ethanol. In a specific embodiment, a weight percentage of the silica sol in the raw material of the porous alumina ceramic is 8% to 10%.

The silica sol can be a type of silica sol for refractory materials produced by Shangyu Yinyu Silicon Products Co., Ltd.

In the illustrated embodiment, the silica sol is prepared by the following steps: sodium silicate is mixed with water and diluted, a supernatant can be obtained after sedimentation, wherein n of Na₂O:nSiO₂ in the supernatant is 2.2 to 3.7. Under a constant stirring condition, an aqueous solution of NaHCO₃ with a weight percentage concentration of 3% to 6% is added in the supernatant by a mass ratio of 1:1, mixing and stirring until there is no SiO₂ in the supernatant. And then stirring is continued for 15 minutes to 20 minutes, the precipitate is obtained by filtration and is washed with water until neutral. Afterwards, the precipitate and deionized water with a volume ratio of 1:2 are mixed to obtain a suspension. Under a constant stirring and heating condition, a part of the suspension is added to an aqueous solution of NaOH with a weight percentage concentration of 5% to 7%, the heating is not stopped until a temperature reaches 85° C. to 90° C., and the temperature of 85° C. to 90° C. is held for 2 hours to 3 hours under a continued stirring condition. And then the remaining suspension is added to obtain a mixed solution. The pH value of the mixed solution is adjusted to 8.0 to 9.0, and the reaction is further stirred for 1 hour under the condition of 85° C. to 90° C. to obtain a reactant. The reactant is concentrated until a weight percentage of silica in the reactant ranges from 25% to 30%, thereby obtaining a silica sol.

During the step of mixing and diluting sodium silicate and water, a mass ratio of sodium silicate and water ranges from 1:3 to 1:4.

A mass of the suspension added in the aqueous solution of NaOH with the weight percentage concentration of 5% to 7% represents 10% to 15% of a total mass of the suspension. And a mass ratio of the aqueous solution of NaOH and the part of the suspension is 1:20.

The sodium silicate has a baume degree of 37°Bé to 50°Bé (under the condition of 20° C.).

The step of concentrating the reactant until the weight percentage of silica in the reactant ranging from 25% to 30% includes: the reactant is concentrated by using a semipermeable membrane device for 1 hour to 3 hours. After concentration, the weight percentage of silica in the reactant is measured to be 25% to 30%.

Silica sol serves as a binding phase between the alumina and the diatomite. Silica sol enables an in-situ formation of a mullite phase at a contact position of the alumina and the diatomite, and thereby bonding the alumina and the diatomite together. As mullite (3Al₂O₃.2SiO₂) is the only stable phase of the aluminum silicate system at high temperatures and at normal atmospheric pressure, and this phase has a high refractoriness, low thermal expansion and thermal conductivity, low creep rate, good chemical and thermal stability, high toughness and strength, and other excellent performance, an addition of the silica sol is beneficial to further improving the strength of the porous alumina ceramic.

In the raw materials of aforementioned porous alumina ceramic, the diatomite is used as the pore forming agent. Since the diatomite is the biomineral material formed by millions of years of sedimentary mineralization of the remains of the single-celled lower aquatic plant diatoms in sea and river, the use of diatomite as the pore forming agent can enable the porous alumina ceramic to have a unique and orderly arranged microporous structure, such that the ceramic has a high porosity, a suitable pore diameter, and a higher open porosity. The alumina makes the ceramic has a good strength. The silica sol serves as the binding phase between the alumina and the diatomite. The strength of the porous alumina ceramic is further enhanced by in-situ formation of the mullite phase at the contact position of the alumina and the diatomite, such that the porous alumina ceramic cooperatively obtained by diatomite, alumina, and silica sol has a good permeability and an excellent strength.

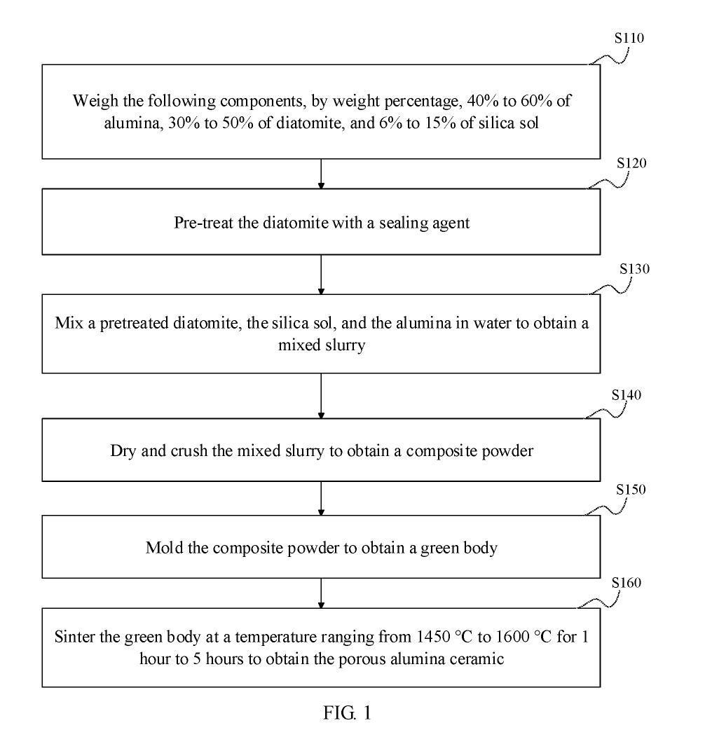

Referring to FIG. 1, a method of preparing the porous alumina ceramic according to an embodiment is provided, which can be used to prepare the aforementioned porous alumina ceramic. The preparation method includes the following steps:

In step S110, the following components are weighed by weight percentage: 40% to 60% of alumina, 30% to 50% of diatomite, and 6% to 15% of silica sol.

The alumina is preferably α-alumina.

The diatomite serves as a pore forming agent. Silica sol serves as a binding phase between the alumina and the diatomite. Silica sol enables an in-situ formation of a mullite phase at a contact position of the alumina and the diatomite, and thereby bonding the alumina and the diatomite together. As mullite (3Al₂O₃.2SiO₂) is the only stable phase of the aluminum silicate system at high temperatures and at normal atmospheric pressure, and this phase has a high refractoriness, low thermal expansion and thermal conductivity, low creep rate, good chemical and thermal stability, high toughness and strength, and other excellent performance, an addition of the silica sol is beneficial to further improving the strength of the porous alumina ceramic.

The diatomite has a pore diameter of 40 μm to 80 μm.

A weight percentage of silica in the silica sol is 25% to 30%. The silica sol can be a dispersion of silica particles in water or in a solvent such as ethanol. In a specific embodiment, a weight percentage of the silica sol in the raw material of the porous alumina ceramic is 8% to 10%.

The silica sol can be a type of silica sol for refractory materials produced by Shangyu Yinyu Silicon Products Co., Ltd.

In the illustrated embodiment, the silica sol is prepared by the following steps: sodium silicate is mixed with water and diluted, a supernatant can be obtained after sedimentation, wherein n of Na₂O:nSiO₂ in the supernatant is 2.2 to 3.7. Under a constant stirring condition, an aqueous solution of NaHCO₃ with a weight percentage concentration of 3% to 6% is added in the supernatant by a mass ratio of 1:1, mixing and stirring until there is no SiO₂ in the supernatant. And then stirring is continued for 15 minutes to 20 minutes, the precipitate is obtained by filtration and is washed with water until neutral. Afterwards, the precipitate and deionized water with a volume ratio of 1:2 are mixed to obtain a suspension. Under a constant stirring and heating condition, a part of the suspension is added to an aqueous solution of NaOH with a weight percentage concentration of 5% to 7%, the heating is not stopped until a temperature reaches 85° C. to 90° C., and the temperature of 85° C. to 90° C. is held for 2 hours to 3 hours under a continued stirring condition. And then the remaining suspension is added to obtain a mixed solution. The pH value of the mixed solution is adjusted to 8.0 to 9.0, and the reaction is further stirred for 1 hour under the condition of 85° C. to 90° C. to obtain a reactant. The reactant is concentrated until a weight percentage of silica in the reactant ranges from 25% to 30%, thereby obtaining a silica sol.

During the step of mixing and diluting sodium silicate and water, a mass ratio of sodium silicate and water ranges from 1:3 to 1:4.

A mass of the suspension added in the aqueous solution of NaOH with the weight percentage concentration of 5% to 7% represents 10% to 15% of a total mass of the suspension. And a mass ratio of the aqueous solution of NaOH and the part of the suspension is 1:20.

The sodium silicate has a baume degree of 37° Bé to 50° Bé (under the condition of 20° C.).

The step of concentrating the reactant until the weight percentage of silica in the reactant ranging from 25% to 30% includes: the reactant is concentrated by using a semipermeable membrane device for 1 hour to 3 hours. After concentration, the weight percentage of silica in the reactant is measured to be 25% to 30%.

In step S120, the diatomite is pretreated with a sealing agent.

The sealing agent is paraffin wax or polyethylene glycol. The diatomite is pretreated with the sealing agent at first to seal pores of the diatomite, thereby preventing other raw materials from entering the pores of the diatomite during the subsequent mixing of the raw materials, which can avoid the problem of reducing the porosity of the porous ceramic and poor pore connectivity. The sealing agent will volatile at a high temperature without affecting the porosity of the porous alumina ceramic.

Specifically, prior to the step of pre-treating the diatomite with the sealing agent, the method further includes a step of granulating the diatomite. Specifically, the diatomite is ball-milled, and then is sifted through a 100 mesh to 200 mesh sieve.

In step S120, the step of pre-treating the diatomite with the sealing agent includes: the sealing agent is dissolved in a solvent to obtain a pretreatment solution, wherein a mass ratio of the sealing agent and the diatomite ranges from 10 to 25:100. And then, the pretreatment solution is added after the diatomite is vacuumized until a vacuum degree ranges from 5 Pa to 10 Pa, followed by filtration and drying to obtain the pretreated diatomite. The pretreatment liquid can be successfully sucked into the pores of the diatomite by vacuumizing the diatomite earth and then adding the pretreatment solution to mix. Specifically, the step of vacuumizing the diatomite earth until the degree of vacuum ranges from 5 Pa to 10 Pa specifically includes: the diatomite is placed in a vacuum container and then is vacuumized until the vacuum degree in the vacuum container ranges from 5 Pa to 10 Pa.

After the diatomite is vacuumized, a drying temperature of the drying step after the step of adding the pretreatment solution ranges from 20° C. to 40° C.

A weight percentage of the sealing agent in the pretreatment solution is 10% to 20%.

The solvent can be a common organic solvent. In the illustrated embodiment, the solvent is kerosene, n-hexane or xylene.

In step S130, the pretreated diatomite, the silica sol, and the alumina are mixed in water to obtain a mixed slurry.

Specifically, the step of mixing the pretreated diatomite, the silica sol, and the alumina in water includes: the alumina is ball-milled in water for 10 hours to 30 hours to obtain an alumina slurry; and subsequently the pretreated diatomite, the silica sol, and the alumina slurry are mixed and ball-milled. The silica sol and the alumina slurry are mixed and ball-milled for 5 hours to 10 hours.

More specifically, during the step of ball-milling the alumina in water, a mass ratio of the alumina, a ball mill medium and the water ranges from 1:3˜5:0.5˜1.

During the step of mixing and ball-milling the pretreated diatomite, the silica sol, and the alumina slurry, a rotating speed during ball milling is 5 r/min to 15 r/min. In addition, during the step of mixing and ball-milling the pretreated diatomite, the silica sol, and the alumina slurry, a ratio of a sum of mass of the pretreated diatomite, the silica sol, and the alumina slurry to that of the ball mill medium ranges from 1:0.5 to 1. The purpose of mixing by low speed ball milling and controlling a ratio of materials and balls is to minimize the damage of pretreated diatomite by the ball mill medium during ball-mill mixing, thereby avoiding the decrease of particle size of the pretreated diatomite.

In step S140, the mixed slurry is dried and crushed to obtain a composite powder.

Specifically, prior to the step of drying the mixed slurry, the method further includes a step of performing vacuum filtration on the mixed slurry. This step can remove excess moisture and prevent the mixed slurry from delamination during drying due to the small viscosity of the mixed slurry.

In step S140, the mixed slurry is dried at a temperature ranging from 40° C. to 50° C.

In step S150, the composite powder is molded to obtain a green body.

Prior to the step of molding the composite powder, the method further includes a step of sifting the composite powder. Specifically, the composite powder is sifted through a 60 mesh to 100 mesh sieve.

The molding method of the composite powder can be dry pressing, isostatic pressing or injection molding.

In step S160, the green body is sintered at a temperature ranging from 1450° C. to 1600° C. for 1 hour to 5 hours to obtain the porous alumina ceramic.

Prior to the step of sintering the green body, the method further includes a step of removing organic substances and water from the green body. The step of removing organic substances and water from the green body includes: the green body is heated to a temperature of 300° C. at a rate of 1° C./min to 2° C./min and the temperature is held for 2 hours to 4 hours, and then the green body is heated to a temperature of 650° C. at a rate of 2° C./min to 4° C./min and the temperature is held for 2 hours to 4 hours, thereby completing the removal of moisture and organic substances.

Specifically, the step S160 is carried out in an air sintering furnace.

The aforementioned preparation method is simple. The diatomite is pretreated with the sealing agent at first to seal the pores of the diatomite before the diatomite is mixed with the alumina and the silica sol, thereby preventing other raw materials from permeating the pores of the diatomite during the mixing of the diatomite and the alumina and other raw materials, which can avoid the problem of reducing the porosity of the ceramic. While since the diatomite is a biomineral material formed by millions of years of sedimentary mineralization of the remains of the single-celled lower aquatic plant diatoms in sea and river, the use of diatomite as the pore forming agent can enable the porous alumina ceramic to have a unique and orderly arranged microporous structure, such that the ceramic has a high porosity, a suitable pore diameter, and a higher open porosity. The alumina makes the ceramic has a good strength. The silica sol serves as the binding phase between the alumina and the diatomite. The strength of the porous alumina ceramic is further enhanced by in-situ formation of the mullite phase at the contact position of the alumina and the diatomite, such that the porous alumina ceramic cooperatively obtained by diatomite, alumina, and silica sol has a good permeability and an excellent strength.

The following is specific examples:

### Example 1

The porous alumina ceramic of the illustrated embodiment is prepared as follows:

(1) Sodium silicate with a baume degree of 37°Bé (under the condition of 20° C.) was provided. The sodium silicate and water were mixed by a mass ratio of sodium silicate to water of 1:4 and diluted. A supernatant can be obtained after natural sedimentation to clarification, wherein n of Na₂O:nSiO₂ in the supernatant was 2.2. Under a constant stirring condition, an aqueous solution of NaHCO₃ with a weight percentage concentration of 3% was added in the supernatant by a mass ratio of 1:1, mixing and stirring until there was no SiO₂ in the supernatant. And then stirring was continued for 15 minutes, the precipitate was obtained by filtration and was washed with water until neutral. Afterwards, the precipitate and deionized water were mixed by a volume ratio of the precipitate to deionized water of 1:2 and stirred to obtain a suspension. An aqueous solution of NaOH with a weight percentage concentration of 5% was added in a reaction kettle, wherein a mass ratio of the aqueous solution of NaOH to the supernatant was 1:20. Under a constant stirring and heating condition, a part of the suspension was added, the heating was not stopped until a temperature was 85° C., and the temperature was held at 85° C. for 2 hours under a continued stirring condition. And then the remaining suspension was added to obtain a mixed solution. The pH value of the mixed solution was adjusted to 8.0, and the reaction was further stirred for 1 hour under the condition of 85° C. to obtain a reactant. The reactant was concentrated by using a semipermeable membrane device until a weight percentage of silica in the reactant was 25%, thereby obtaining a silica sol. A mass of the suspension added in the aqueous solution of NaOH represented 10% of a total mass of the suspension.

(2) The following components were weighed by weight percentage: 40% of alumina, 50% of diatomite, and 10% of silica sol, wherein the diatomite had a pore diameter of 80 μm.

(3) The paraffin was dissolved in kerosene to obtain a pretreatment solution with a weight percentage of paraffin of 20%, wherein a mass ratio of the paraffin to the diatomite was 15:100.

(4) The diatomite was ball-milled in a ball mill, and then was sifted through a 100 mesh sieve. The sieved diatomite was placed into a vacuum container, and was vacuumized until a vacuum degree in the vacuum container was 5 Pa. The pretreatment solution was poured into the diatomite. At this time, the pretreatment solution entered into pores of the diatomite, followed by filtration, and then dried in an oven at 20° C. to obtain a pretreated diatomite.

(5) The alumina was ball-milled in water for 10 hours by a mass ratio of the alumina, a ball mill medium and water of 1:5:0.5, to obtain an alumina slurry. The pretreated diatomite, the silica sol, and the alumina slurry was placed together in a ball mill tank, and was ball-milled and mixed at a rotating speed of 5 r/min to obtain a mixed slurry. A ratio of a sum of mass of the pretreated diatomite, the silica sol, and the alumina slurry to that of the ball mill medium was 1:0.5.

(6) The mixed slurry was vacuum filtered, and the residue was then dried in a drying oven at 40° C. for 10 hours, and then was crushed and sifted through a 100 mesh sieve to obtain a composite powder.

(7) The composite powder was dry pressed to obtain a green body.

(8) The green body was placed into a debinding furnace, and was heated to a temperature of 300° C. at a rate of 1° C./min and held for 2 hours. Then the green body was heated to a temperature of 650° C. at a rate of 2° C./min and held for 2 hours, thereby completing the removal of moisture and organic substances. The green body was then placed in an air sintering furnace and sintered at a temperature of 1500° C. for 2 hours to obtain the porous alumina ceramic. At this time, the porous alumina ceramic can be trimmed in accordance with requirements.

The porosity, average pore diameter, and open porosity of the porous alumina ceramic according to the illustrated example were measured by GB/T 1966-1996 and GB/T 1967-1996 standard methods, and the compressive strength of the porous alumina ceramic according to the illustrated example was measured by the standard of GB/T 4740-1999. The porosity, average pore diameter, open porosity, and compressive strength of the porous alumina ceramic of the present example are shown in Table 1.

### Example 2

The porous alumina ceramic of the illustrated embodiment is prepared as follows:

(1) Sodium silicate with a baume degree of 40° Bé (under the condition of 20° C.) was provided. The sodium silicate and water were mixed by a mass ratio of sodium silicate to water of 1:3 and diluted. A supernatant can be obtained after natural sedimentation to clarification, wherein n of Na₂O:nSiO₂ in the supernatant was 3. Under a constant stirring condition, an aqueous solution of NaHCO₃ with a weight percentage concentration of 5% was added in the supernatant by a mass ratio of 1:1, mixing and stirring until there was no SiO₂ in the supernatant. And then stirring was continued for 20 minutes, the precipitate was obtained by filtration and was washed with water until neutral. Afterwards, the precipitate and deionized water were mixed by a volume ratio of the precipitate to deionized water of 1:2 and stirred to obtain a suspension. An aqueous solution of NaOH with a weight percentage concentration of 5% was added in a reaction kettle, wherein a mass ratio of the aqueous solution of NaOH to the supernatant was 1:20. Under a constant stirring and heating condition, a part of the suspension was added, the heating was not stopped until a temperature was 90° C., and the temperature was held at 90° C. for 2 hours under a continued stirring condition. And then the remaining suspension was added to obtain a mixed solution. The pH value of the mixed solution was adjusted to 8.5, and the reaction was further stirred for 1 hour under the condition of 90° C. to obtain a reactant. The reactant was concentrated by using a semipermeable membrane device until a weight percentage of silica in the reactant was 28%, thereby obtaining a silica sol. A mass of the suspension added in the aqueous solution of NaOH represented 15% of a total mass of the suspension.

(2) The following components were weighed by weight percentage: 50% of alumina, 42% of diatomite, and 8% of silica sol, wherein the diatomite had a pore diameter of 50 μm.

(3) The paraffin was dissolved in xylene to obtain a pretreatment solution with a weight percentage of paraffin of 15%, wherein a mass ratio of the paraffin to the diatomite was 10:100.

(4) The diatomite was ball-milled in a ball mill, and then was sifted through a 150 mesh sieve. The sieved diatomite was placed into a vacuum container, and was vacuumized until a vacuum degree in the container was 7 Pa. The pretreatment solution was poured into the diatomite, such that the pretreatment solution entered into pores of the diatomite, followed by filtration, and then dried in an oven at 25° C. to obtain a pretreated diatomite.

(5) The alumina was ball-milled in water for 15 hours by a mass ratio of the alumina, a ball mill medium and water of 1:3:0.6, to obtain an alumina slurry. The pretreated diatomite, the silica sol, and the alumina slurry was placed together in a ball mill tank, and was ball-milled and mixed at a rotating speed of 15 r/min to obtain a mixed slurry. A ratio of a sum of mass of the pretreated diatomite, the silica sol, and the alumina slurry to that of the ball mill medium was 1:0.6.

(6) The mixed slurry was vacuum filtered, and the residue was then dried in a drying oven at 41° C. for 12 hours, and then was crushed and sifted through a 60 mesh sieve to obtain a composite powder.

(7) The composite powder was isostatic pressed to obtain a green body.

(8) The green body was placed into a debinding furnace, and was heated to a temperature of 300° C. at a rate of 2° C./min and held for 4 hours. Then the green body was heated to a temperature of 650° C. at a rate of 4° C./min and held for 4 hours, thereby completing the removal of moisture and organic substances. The green body was then placed in an air sintering furnace and sintered at a temperature of 1520° C. for 2.5 hours to obtain the porous alumina ceramic. At this time, the porous alumina ceramic can be trimmed in accordance with requirements.

The porosity, average pore diameter, and open porosity of the porous alumina ceramic according to the illustrated example were measured in the same manner as in Example 1, and the compressive strength of the porous alumina ceramic according to the illustrated example was measured in the same manner as in Example 1. The porosity, average pore diameter, open porosity, and compressive strength of the porous alumina ceramic of the present example are shown in Table 1.

### Example 3

The porous alumina ceramic of the illustrated embodiment is prepared as follows:

(1) Sodium silicate with a baume degree of 50Bé (under the condition of 20° C.) was provided. The sodium silicate and water were mixed by a mass ratio of sodium silicate to water of 1:3 and diluted. A supernatant can be obtained after natural sedimentation to clarification, wherein n of Na₂O:nSiO₂ in the supernatant was 3.7. Under a constant stirring condition, an aqueous solution of NaHCO₃ with a weight percentage concentration of 6% was added in the supernatant by a mass ratio of 1:1, mixing and stirring until there was no SiO₂ in the supernatant. And then stirring was continued for 15 minutes, the precipitate was obtained by filtration and was washed with water until neutral. Afterwards, the precipitate and deionized water were mixed by a volume ratio of the precipitate to deionized water of 1:2 and stirred, to obtain a suspension. An aqueous solution of NaOH with a weight percentage concentration of 7% was added in a reaction kettle, wherein a mass ratio of the aqueous solution of NaOH to the supernatant was 1:20. Under a constant stirring and heating condition, a part of the suspension was added, the heating was not stopped until a temperature was 90° C., and the temperature was held at 90° C. for 3 hours under a continued stirring condition. And then the remaining suspension was added to obtain a mixed solution. The pH value of the mixed solution was adjusted to 9.0, and the reaction was further stirred for 1 hour under the condition of 90° C. to obtain a reactant. The reactant was concentrated by using a semipermeable membrane device until a weight percentage of silica in the reactant was 30%, thereby obtaining a silica sol. A mass of the suspension added in the aqueous solution of NaOH represented 10% of a total mass of the suspension.

(2) The following components were weighed by weight percentage: 60% of alumina, 30% of diatomite, and 10% of silica sol, wherein the diatomite had a pore diameter of 40 μm.

(3) The polyethylene glycol was dissolved in n-hexane to obtain a pretreatment solution with a weight percentage of polyethylene glycol of 20%, wherein a mass ratio of the polyethylene glycol to the diatomite was 25:100.

(4) The diatomite was ball-milled in a ball mill, and then was sifted through a 200 mesh sieve. The sieved diatomite was placed into a vacuum container, and was vacuumized until a vacuum degree in the container was 10 Pa. The pretreatment solution was poured into the diatomite, such that the pretreatment solution entered into pores of the diatomite, followed by filtration, and then dried at 40° C. to obtain a pretreated diatomite.

(5) The alumina was ball-milled in water for 22 hours by a mass ratio of the alumina, a ball mill medium and water of 1:5:1, to obtain an alumina slurry. The pretreated diatomite, the silica sol, and the alumina slurry was placed together in a ball mill tank, and was ball-milled and mixed at a rotating speed of 9 r/min to obtain a mixed slurry. A ratio of a sum of mass of the pretreated diatomite, the silica sol, and the alumina slurry to that of the ball mill medium was 1:1.

(6) The mixed slurry was vacuum filtered, and the residue was then dried in a drying oven at 50° C. for 13 hours, and then was crushed and sifted through a 100 mesh sieve to obtain a composite powder.

(7) The composite powder was injection molded to obtain a green body.

(8) The green body was placed into a debinding furnace, and was heated to a temperature of 300° C. at a rate of 2° C./min and held for 3 hours. Then the green body was heated to a temperature of 650° C. at a rate of 4° C./min and held for 3 hours. After the completion of the removal of moisture and organic substances, the green body was placed into an air sintering furnace and sintered at 1600° C. for 5 hours to obtain the porous alumina ceramic. At this time, the porous alumina ceramic can be trimmed in accordance with requirements.

The porosity, average pore diameter, and open porosity of the porous alumina ceramic according to the illustrated example were measured in the same manner as in Example 1, and the compressive strength of the porous alumina ceramic according to the illustrated example was measured in the same manner as in Example 1. The porosity, average pore diameter, open porosity, and compressive strength of the porous alumina ceramic of the present example are shown in Table 1.

### Comparative Example 1

The porous alumina ceramic of comparative example 1 is prepared as follows:

(1) The following components were weighed by weight percentage: 40% of alumina and 60% of graphite, wherein the graphite had a particle size of 80 μm.

(2) The alumina, the graphite, and water was placed in a ball mill tank, and was ball-milled and mixed at a rotating speed of 10 r/min for 10 hours to obtain a mixed slurry. A mass ratio of a sum of mass of the alumina and the graphite to the ball mill medium and water was 1:2:0.5.

(5) The mixed slurry was dried in a drying oven at 80° C. for 20 hours, and then was crushed and sifted through a 100 mesh sieve to obtain a composite powder.

(6) The composite powder was dry pressed to obtain a green body.

(7) The green body was placed into a debinding furnace, and was heated to a temperature of 300° C. at a rate of 1° C./min and held for 2 hours. Then the green body was heated to a temperature of 650° C. at a rate of 2° C./min and held for 2 hours, thereby completing the removal of moisture and organic substances. The green body was then placed in an air sintering furnace and sintered at a temperature of 1500° C. for 2 hours to obtain the porous alumina ceramic. At this time, the porous alumina ceramic can be trimmed in accordance with requirements.

The porosity, average pore diameter, and open porosity of the porous alumina ceramic of comparative example 1 were measured in the same manner as in Example 1, and the compressive strength of the porous alumina ceramic of comparative example 1 was measured in the same manner as in Example 1. The porosity, average pore diameter, open porosity, and compressive strength of the porous alumina ceramic of comparative example 1 are shown in Table 1.

### Comparative Example 2

The porous alumina ceramic of comparative example 2 is prepared as follows:

(1) The following components were weighed by weight percentage: 50% of alumina and 50% of graphite, wherein the graphite had a particle size of 50 μm.

(2) The alumina, the graphite, and water was placed in a ball mill tank, and was ball-milled and mixed at a rotating speed of 8 r/min for 12 hours to obtain a mixed slurry. A mass ratio of a sum of mass of the alumina and the graphite to the ball mill medium and water was 1:2:0.6.

(5) The mixed slurry was dried in a drying oven at 85° C. for 24 hours, and then was crushed and sifted through a 150 mesh sieve to obtain a composite powder.

(6) The composite powder was isostatic pressed to obtain a green body.

(7) The green body was placed into a debinding furnace, and was heated to a temperature of 300° C. at a rate of 2° C./min and held for 4 hours. Then the green body was heated to a temperature of 650° C. at a rate of 4° C./min and held for 4 hours, thereby completing the removal of moisture and organic substances. After removing the organic substances and water from the green body, the green body was then placed in an air sintering furnace and sintered at a temperature of 1520° C. for 2.5 hours to obtain the porous alumina ceramic. At this time, the porous alumina ceramic can be trimmed in accordance with requirements.

The porosity, average pore diameter, and open porosity of the porous alumina ceramic of comparative example 2 were measured in the same manner as in Example 1, and the compressive strength of the porous alumina ceramic of comparative example 2 was measured in the same manner as in Example 1. The porosity, average pore diameter, open porosity, and compressive strength of the porous alumina ceramic of comparative example 2 are shown in Table 1.

### Comparative Example 3

The porous alumina ceramic of comparative example 3 is prepared as follows:

(1) The following components were weighed by weight percentage: 60% of alumina and 40% of graphite, wherein the graphite had a particle size of 40 μm.

(2) The alumina, the graphite, and water was placed in a ball mill tank, and was ball-milled and mixed at a rotating speed of 9 r/min for 8 hours to obtain a mixed slurry. A mass ratio of a sum of mass of the alumina and the graphite to the ball mill medium and water was 1:1:0.5.

(5) The mixed slurry was dried in a drying oven at 50° C. for 13 hours, and then was crushed and sifted through a 100 mesh sieve to obtain a composite powder.

(6) The composite powder was injection molded to obtain a green body.

(7) The green body was placed into a debinding furnace, and was heated to a temperature of 300° C. at a rate of 2° C./min and held for 3 hours. Then the green body was heated to a temperature of 650° C. at a rate of 4° C./min and held for 3 hours. After the completion of the removal of moisture and organic substances, the green body was placed into the air sintering furnace and sintered at 1600° C. for 5 hours to obtain the porous alumina ceramic. At this time, the porous alumina ceramic can be trimmed in accordance with requirements.

The porosity, average pore diameter, and open porosity of the porous alumina ceramic of comparative example 3 were measured in the same manner as in Example 1, and the compressive strength of the porous alumina ceramic of comparative example 3 was measured in the same manner as in Example 1. The porosity, average pore diameter, open porosity, and compressive strength of the porous alumina ceramic of comparative example 3 are shown in Table 1.

### Comparative Example 4

The porous alumina ceramic of comparative example 4 is prepared as follows:

(1) The following components were weighed by weight percentage: 40% of alumina and 60% of diatomite, wherein the diatomite had a pore diameter of 80 μm.

(2) The diatomite was ball-milled in a ball mill, and then was sifted through a 100 mesh sieve.

(3) The alumina was ball-milled in water for 10 hours by a mass ratio of the alumina, a ball mill medium and water of 1:5:0.5, to obtain an alumina slurry. The diatomite and the alumina slurry was placed together in a ball mill tank, and was ball-milled and mixed at a rotating speed of 5 r/min to obtain a mixed slurry. A ratio of a sum of mass of the diatomite and the alumina slurry to that of the ball mill medium was 1:0.5.

(4) The mixed slurry was vacuum filtered, and the residue was then dried in a drying oven at 40° C. for 10 hours, and then was crushed and sifted through a 100 mesh sieve to obtain a composite powder.

(5) The composite powder was dry pressed to obtain a green body.

(6) The green body was placed into a debinding furnace, and was heated to a temperature of 300° C. at a rate of 2° C./min and held for 3 hours. Then the green body was heated to a temperature of 650° C. at a rate of 4° C./min and held for 3 hours. After the completion of the removal of moisture and organic substances, the green body was placed into an air sintering furnace and sintered at 1500° C. for 2 hours to obtain the porous alumina ceramic. At this time, the porous alumina ceramic can be trimmed in accordance with requirements.

The porosity, average pore diameter, and open porosity of the porous alumina ceramic of comparative example 4 were measured in the same manner as in Example 1, and the compressive strength of the porous alumina ceramic of comparative example 4 was measured in the same manner as in Example 1. The porosity, average pore diameter, open porosity, and compressive strength of the porous alumina ceramic of comparative example 4 are shown in Table 1.

### Comparative Example 5

The porous alumina ceramic of comparative example 5 is prepared as follows:

(1) Sodium silicate with a baume degree of 37° Bé (under the condition of 20° C.) was provided. The sodium silicate and water were mixed by a mass ratio of sodium silicate to water of 1:4 and diluted. A supernatant can be obtained after natural sedimentation to clarification, wherein n of Na₂O:nSiO₂ in the supernatant was 2.2. Under a constant stirring condition, an aqueous solution of NaHCO₃ with a weight percentage concentration of 3% was added in the supernatant by a mass ratio of 1:1, mixing and stirring until there was no SiO₂ in the supernatant. And then stirring was continued for 15 minutes, the precipitate was obtained by filtration and was washed with water until neutral. Afterwards, the precipitate and deionized water were mixed by a volume ratio of the precipitate to deionized water of 1:2 and stirred, to obtain a suspension. An aqueous solution of NaOH with a weight percentage concentration of 5% was added in a reaction kettle, wherein a mass ratio of the aqueous solution of NaOH to the supernatant was 1:20. Under a constant stirring and heating condition, a part of the suspension was added, the heating was not stopped until a temperature was 85° C., and the temperature was held at 85° C. for 2 hours under a continued stirring condition. And then the remaining suspension was added to obtain a mixed solution. The pH value of the mixed solution was adjusted to 8.0, and the reaction was further stirred for 1 hour under the condition of 85° C. to obtain a reactant. The reactant was concentrated by using a semipermeable membrane device until a weight percentage of silica in the reactant was 25%, thereby obtaining a silica sol. A mass of the suspension added in the aqueous solution of NaOH represented 10% of a total mass of the suspension.

(2) The following components were weighed by weight percentage: 40% of alumina, 50% of diatomite, and 10% of silica sol, wherein the diatomite had a pore diameter of 80 μm.

(3) The diatomite was ball-milled in a ball mill, and then was sifted through a 100 mesh sieve.

(4) The alumina was ball-milled in water for 10 hours by a mass ratio of the alumina, a ball mill medium and water of 1:5:0.5, to obtain an alumina slurry. The diatomite, the silica sol, and the alumina slurry was placed together in a ball mill tank, and was ball-milled and mixed at a rotating speed of 5 r/min to obtain a mixed slurry. A ratio of a sum of mass of the diatomite, the silica sol, and the alumina slurry to that of the ball mill medium was 1:0.5.

(5) The mixed slurry was vacuum filtered, and the residue was then dried in a drying oven at 40° C. for 10 hours, and then was crushed and sifted through a 100 mesh sieve to obtain a composite powder.

(6) The composite powder was dry pressed to obtain a green body.

(7) The green body was placed into a debinding furnace, and was heated to a temperature of 300° C. at a rate of 1° C./min and held for 2 hours. Then the green body was heated to a temperature of 650° C. at a rate of 2° C./min and held for 2 hours, thereby completing the removal of moisture and organic substances. The green body was then placed in an air sintering furnace and sintered at a temperature of 1500° C. for 2 hours to obtain the porous alumina ceramic. At this time, the porous alumina ceramic can be trimmed in accordance with requirements.

The porosity, average pore diameter, and open porosity of the porous alumina ceramic of comparative example 5 were measured in the same manner as in Example 1, and the compressive strength of the porous alumina ceramic of comparative example 5 was measured in the same manner as in Example 1. The porosity, average pore diameter, open porosity, and compressive strength of the porous alumina ceramic of comparative example 5 are shown in Table 1.

Table 1 shows the porosity, average pore diameter, open porosity, and compressive strength of the porous alumina ceramic of Examples 1 to 3 and Comparative Example 1 to 5.

TABLE 1

| | | Average pore | Open | Compressive |
|---|---|---|---|---|
| | Porosity | diameter | porosity | strength |
| | (%) | (μm) | (%) | (MPa) |
| Example 1 | 60 | 75 | 95 | 500 |
| Example 2 | 48 | 42 | 88 | 600 |
| Example 3 | 35 | 30 | 65 | 660 |
| Comparative | 45 | 40 | 72 | 400 |
| Example 1 | | | | |
| Comparative | 39 | 28 | 52 | 490 |
| Example 2 | | | | |
| Comparative | 25 | 21 | 25 | 550 |
| Example 3 | | | | |
| Comparative | 63 | 77 | 96 | 450 |
| Example 4 | | | | |
| Comparative | 41 | 58 | 55 | 700 |
| Example 5 | | | | |

As can be seen from Table 1, the porous alumina ceramics of Examples 1 to 3 each had a higher porosity, a higher average pore diameter, and a higher opening porosity than those of Comparative Examples 1 to 3, in which almost equal proportions of graphite pore forming agent were added. In other words, the porous alumina ceramics of Examples 1 to 3 had a better permeability. In addition, the compressive strength of the porous alumina ceramics of Examples 1 to 3 was apparently better than those of Comparative Examples 1 to 3 which used graphite as the pore forming agent. Therefore, the porous alumina ceramics of Examples 1 to 3 had a higher porosity and a better intensity.

Meanwhile, the porous alumina ceramic of Comparative Example 4 shows a significant decrease in compressive strength as compared with the porous alumina ceramic of Example 1 because no silica sol was used as a binding phase during sintering, while the porosity and the pore diameter thereof are comparable to those of Example 1. Therefore, the use of silica sol as the binder phase during sintering can effectively improve the mechanical properties of the porous alumina ceramics.

The porous alumina ceramic of Comparative Example 5 has the same raw material composition as that of the porous alumina ceramic of Example 1. However, since no sealing agent is used to seal the diatomite, the silica sol and the alumina slurry enter the pores of the diatomite during mixing, greatly reducing the porosity and the pore diameter of the porous alumina ceramic.

What is claimed is:

1. A porous alumina ceramic, wherein a raw material of the porous alumina ceramic comprises the following components: by weight percentage, 40% to 60% of alumina, 30% to 50% of diatomite, and 6% to 15% of silica sol, wherein a weight percentage of silica in the silica sol is 25% to 30%.

2. A method of preparing a porous alumina ceramic, comprising the following steps of:
weighing the following components, by weight percentage, 40% to 60% of alumina, 30% to 50% of diatomite, and 6% to 15% of silica sol, wherein a weight percentage of silica in the silica sol is 25% to 30%;
pre-treating the diatomite with a sealing agent, wherein the sealing agent is paraffin wax or polyethylene glycol;
mixing a pretreated diatomite, the silica sol, and the alumina in water to obtain a mixed slurry;
drying and crushing the mixed slurry to obtain a composite powder;
molding the composite powder to obtain a green body; and
sintering the green body at a temperature ranging from 1450° C. to 1600° C. for 1 hour to 5 hours to obtain the porous alumina ceramic.

3. The method of preparing the porous alumina ceramic according to claim 2, wherein the step of pre-treating the diatomite with the sealing agent comprises:
dissolving the sealing agent in a solvent to obtain a pretreatment solution, wherein a mass ratio of the sealing agent and the diatomite ranges from 10 to 25:100;
adding the pretreatment solution after the diatomite is vacuumized until a vacuum degree ranges from 5 Pa to 10 Pa, and then obtaining the pretreated diatomite after filtration and drying.

4. The method of preparing the porous alumina ceramic according to claim 3, wherein a weight percentage of the sealing agent in the pretreatment solution is 10% to 20%.

5. The method of preparing the porous alumina ceramic according to claim 3, wherein the solvent is kerosene, n-hexane or xylene.

6. The method of preparing the porous alumina ceramic according to claim 2, wherein prior to the step of pre-treating the diatomite with a sealing agent, the method further comprises a step of granulating the diatomite: ball-milling the diatomite, and then sifting the diatomite through a 100 mesh to 200 mesh sieve.

7. The method of preparing the porous alumina ceramic according to claim 2, wherein the step of mixing the pretreated diatomite, the silica sol, and the alumina in water comprises: ball-milling the alumina in water for 10 hours to 30 hours to obtain an alumina slurry; and then mixing and ball-milling the pretreated diatomite, the silica sol, and the alumina slurry.

8. The method of preparing the porous alumina ceramic according to claim 7, wherein during the step of mixing and ball-milling the pretreated diatomite, the silica sol, and the alumina slurry, a rotating speed during ball milling is 5 to 15 revolutions per minute.

9. The method of preparing the porous alumina ceramic according to claim 7, wherein during the step of mixing and ball-milling the pretreated diatomite, the silica sol, and the alumina slurry, a ratio of a sum of mass of the pretreated diatomite, the silica sol, and the alumina slurry to that of a ball mill medium ranges from 1:0.5 to 1.

10. The method of preparing the porous alumina ceramic according to claim 7, wherein during the step of ball-milling the alumina in water, a mass ratio of the alumina, a ball mill medium, and the water ranges from 1:3 to 5:0.5 to 1.
